(19) United States
(12) Patent Application Publication
(10) Pub. No.: US 2024/0403740 A1
(43) Pub. Date: Dec. 5, 2024

(54) DELIVERY PLANNING APPARATUS, DELIVERY PLANNING METHOD, AND PROGRAM

(71) Applicant: NIPPON TELEGRAPH AND TELEPHONE CORPORATION, Tokyo (JP)

(72) Inventors: Zhao WANG, Tokyo (JP); Yusuke NAKANO, Tokyo (JP); Ken NISHIMATSU, Tokyo (JP)

(21) Appl. No.: 18/689,623

(22) PCT Filed: Sep. 29, 2021
(86) PCT No.: PCT/JP2021/035937

§ 371 Date: Mar. 6, 2024

(51) Int. Cl. G06Q 10/047; G01C 21/36; G06Q 10/083

(52) U.S. Cl. CPC G06Q 10/047; G01C 21/3626; G06Q 10/083

(57) ABSTRACT

A vehicle routing device includes an algorithm calculation unit configured to solve a vehicle routing problem that determines a route for providing a service to a plurality of customers by a vehicle starting from a service center using a neural network performing reinforcement learning by an actor-critic scheme. The algorithm calculation unit solves the vehicle routing problem with a time window indicating a range of a time to arrive at a customer and a time cost indicating a time length taken to provide the service to the customer as constraints.

### TECHNICAL FIELD

The present invention relates to a technology for solving a vehicle routing problem.

### BACKGROUND ART

A vehicle routing problem (VRP) is an optimization problem for considering which service vehicle is optimum (which cost is the lowest) to which customer in which order when cargo is delivered to each customer by using a service vehicle from a cargo stock station (service center). The “vehicle routing problem” may be referred to as a “vehicle allocation problem”.

In actual applications, there are many practical business scenarios such as just-in-time delivery, cold chain delivery, and store replenishment of electronic commerce in which distribution and service costs through solutions of the VRP can be optimized.

Therefore, various variations of the VRP have been proposed in accordance with different actual requirements. As a variation of the VRP, there is, for example, a VRP with a time window (VRPTW). In the VRPTW, a time window for delivery of commodities is set for a customer. Another VRP includes a multi-depot vehicle routing problem (MDVRP). In the MDVRP, there are a plurality of depots (service centers) in which vehicles can start or end driving.

Since it has been proved that the VRP and the variations are proved to be NP-hard problems, various operational research (OR)-based methods of returning approximate solutions have been studied for many years.

Generally, in an OR-based algorithm, a search model is manually defined, and a solution to a VRP is obtained at the expense of quality of a solution in order to improve efficiency. However, there are two drawbacks in the OR-based method of the related art.

As the first drawback, in a practical-scale VRP problem (having 100 or more customers), when an OR-based algorithm is used, several days or several years are required for calculation in order to obtain an optimal solution or an approximate solution.

As the second drawback, a variation of different VRPs requires different OR algorithms because different handmade search models and initial search conditions are necessary. For example, there is a possibility of an inappropriate initial solution resulting in a long processing time and a local optimal solution. From this point, it is difficult to generalize and use the OR-based algorithm in a real business scenario.

A solution to a VRP based on the reinforcement learning of the actor-critic scheme is disclosed in Non Patent Literature 1. Accordingly, the drawbacks of the OR-based algorithm are solved. That is, a neural network model can greatly improve complexity and an expression capability with high accuracy, particularly when the number of customer nodes is large.

Further, the neural network takes time in a learning phase, but an approximate solution can be found instantaneously in an inference phase, and execution efficiency in a practical business application can be improved significantly.

A data-driven neural network does not need to define a mathematical model for search. Therefore, simply by providing new data and adjusting a reward function or another basic engineering task, application to variations of various VRPs can be made. Thus, it is very convenient for practical research and business development.

### CITATION LIST

### Non Patent Literature

Non Patent Literature 1: Nazari, Mohammadreza, Afshin Oroojlooy, Lawrence V. Snyder, and Martin Takac, “Reinforcement Learning for Solving the Vehicle Routing Problem”, NIPS, 2018.

### SUMMARY OF INVENTION

### Technical Problem

In actual applications, there are many practical business scenarios such as just-in-time delivery, cold chain delivery, and store replenishment of electronic commerce in which distribution and service costs through solutions of the VRP can be optimized.

For example, a communication carrier receives a large number of requests from customers every day, and visits customer homes to support troubleshooting of network faults vehicle from a service center. A time length required for repair varies depending on a type of failure, and a difference in the time length are often greatly different. From the viewpoint of the service center, it is considered that a rational and efficient order and route for repair are planned in order to minimize the number of repair staff members and working times while considering the repair time period designated by the customer, as one of the most necessary means for reducing cost and improving service quality.

The present invention has been made in view of the above-mentioned points and an object of the present invention is to provide a technique for implementing a vehicle routing under a constraint of a time window and a constraint of a time cost by solving a vehicle routing problem in consideration of the constraint of the time window and the constraint of the time cost.

### Solution to Problem

According to the disclosed technique, a vehicle routing device includes an algorithm calculation unit configured to solve a vehicle routing problem that determines a route for providing services to a plurality of customers by a vehicle starting from a service center using a neural network that performs reinforcement learning by an actor-critic scheme.

The algorithm calculation unit solves the vehicle routing problem with a time window indicating a range of time to arrive at a customer and a time cost indicating a time length required for service provision by the customer as a constraint.

### Advantageous Effects of Invention

According to the disclosed technique, it is possible to provide a technique for implementing a vehicle routing under a constraint of a time window and a constraint of a time cost by solving a vehicle routing problem in consideration of the constraint of the time window and the constraint of the time cost.

### BRIEF DESCRIPTION OF DRAWINGS

FIG. 1 is a diagram illustrating a configuration of a device according to an embodiment of the present invention.

FIG. 2 is a diagram illustrating a configuration of an algorithm calculation unit 130.

FIG. 3 is a diagram illustrating a problem setting.

FIG. 4 is a diagram illustrating Algorithm 1.

FIG. 5 is a diagram illustrating Algorithm 2.

FIG. 6 is a diagram illustrating a hardware configuration example of an apparatus.

### DESCRIPTION OF EMBODIMENTS

Embodiments of the present invention (present embodiment) will be described below with reference to the drawings. The embodiments to be described below are merely exemplary, and embodiments to which the present invention is applied are not limited to the following embodiments.

### (Overview of Embodiment)

The overview of the present embodiment will be described below. In the present embodiment, a new VRP called VRPTWTC which is a formulation of a very practical problem in a business scenario is introduced.

In the present embodiment, in formulation of a problem, two new constraints (time window and time cost) are introduced in addition to existing constraints in a VRP such as demand and load in an optimization process. In the present embodiment, “load” assumes “baggage”, “load”, or the like mounted on a service vehicle. The “load” may be replaced with “baggage”, “load”, or the like.

In the present embodiment, in order to solve a VRPTWTC, a data-driven, end-to-end policy (policy)-based reinforcement learning framework is used. The policy-based reinforcement learning framework includes two neural networks of an actor network and a critic network. A route of the VRPTWTC is generated in an actor network, and a value function is estimated and evaluated in a critic network.

In the present embodiment, a new masking algorithm with which the actor network is combined is used. According to the masking algorithm, it is possible to solve a problem under a constraint in a VRP of the related art and a time window constraint and a time cost constraint formulated in the present embodiment.

In the present embodiment, by using an API of a map application based on a map to be implemented, it is possible to calculate the route under an actual road connection condition, and it is possible to increase an adoption likelihood in an actual industry.

### (Exemplary Configuration of Device)

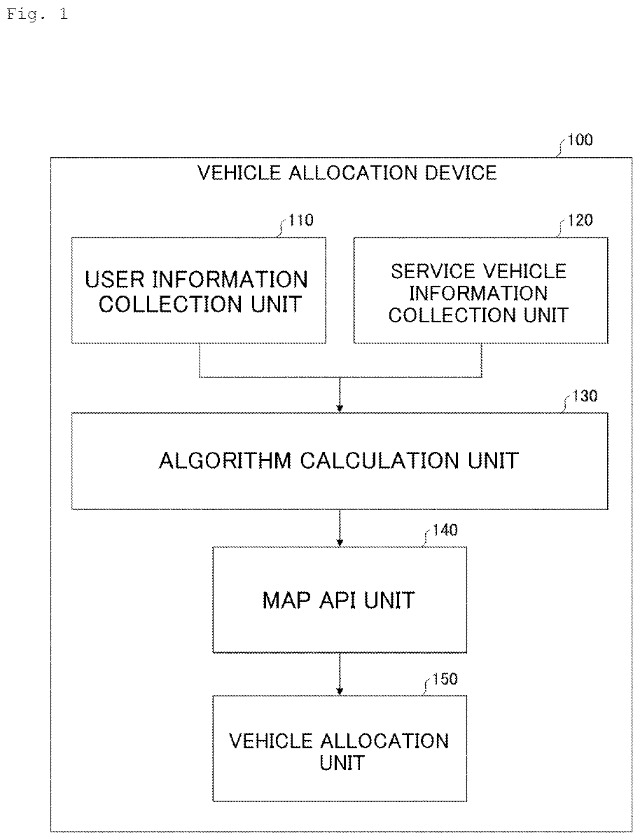

FIG. 1 illustrates an exemplary configuration of a vehicle routing device 100 according to the present embodiment. As illustrated in FIG. 1, the vehicle routing device 100 includes a user information collection unit 110, a service vehicle information collection unit 120, an algorithm calculation unit 130, a map API unit 140, and a vehicle allocation unit 150.

The vehicle routing device 100 may be implemented by one device (computer) or may be implemented by a plurality of devices. For example, the algorithm calculation unit 130 may be mounted in a certain computer, and other functional units may be mounted in another computer. An overview of an operation of the vehicle routing device 100 will be described below.

The user information collection unit 110 acquires a feature of each user (customer). The feature of each user includes, for example, a designated time window and a time cost of a service of each user.

The service vehicle information collection unit 120 collects features of service vehicles. The feature of each service vehicle includes, for example, a departure position or the like of each service vehicle.

The algorithm calculation unit 130 outputs a vehicle routing by solving a VRP problem on the basis of the information regarding each user (customer) and each service vehicle. Details of the algorithm calculation unit 130 will be described below.

The map API unit 140 performs route searching based on the information regarding the vehicle routing output from the algorithm calculation unit 130 and draws a route of the vehicle routing of each service vehicle on a map. The vehicle allocation unit 150 delivers information regarding a service route to each service vehicle (or a terminal of a service center) based on an output result of the map API unit 140 via a network. The vehicle allocation unit 150 may be referred to as an “output unit”.

The map API unit 140 may perform route searching or the like, for example, by accessing an external map server. The map API unit 140 itself may store a map database and perform route searching using the map database.

As an example, it is assumed that, as a vehicle routing, a vehicle routing of “0→2→3→0” is obtained by the algorithm calculation unit 130. Here, 0 indicates the service center, and 2 and 3 indicate customer numbers. In this case, the map API unit 140 draws a route of an actual road of “service center→customer 2→customer 3→service center” on the map, and the vehicle allocation unit 150 outputs map information in which the route is drawn.

### (Exemplary Configuration of Algorithm Calculation Unit 120)

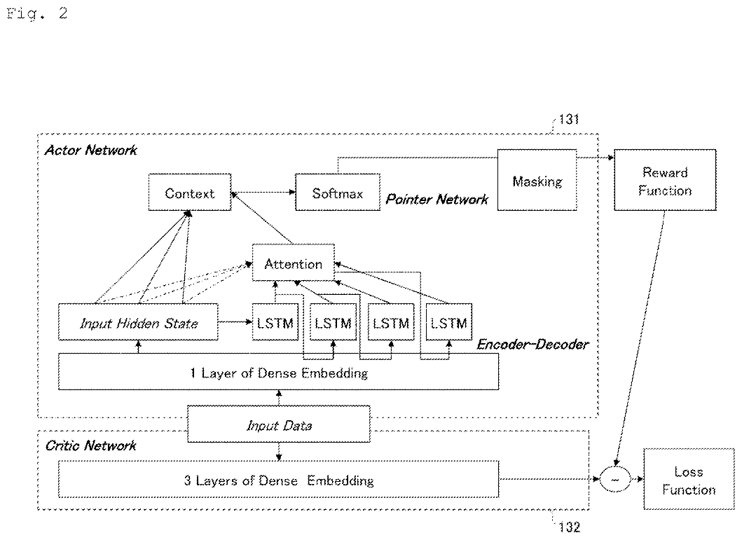

FIG. 2 illustrates an exemplary configuration of the algorithm calculation unit 130. The algorithm calculation unit 130 is a model of a neural network performing reinforcement learning of an actor-critic scheme. This model may be called a VRPTWTC model.

As illustrated in FIG. 2, this model includes two neural networks of the actor network 131 and the critic network 132.

The actor network 131 includes: a dense embedding layer (a layer), an LSTM cell, an attention layer, a Softmax calculation unit (Softmax), and a masking unit. Thus, an encoder-decoder is configured and a pointer network is configured. The critic network 132 has a dense embedding layer (3 layers).

The dense embedding layer, the LSTM cell, and the attention layer in the actor network 131, and the dense embedding layer in the critic network 132 have learnable parameters in the neural network.

In the actor network 131, a feature obtained by the LSTM cell from a hidden state which is an output from a dense embedding layer corresponding to an encoder is input to an attention layer, and a value calculated from a context by Softmax in which the context is obtained by an output from the dense embedding layer and an output from the attention layer is output through masking to be used for reward calculation. In the critic network 132, a loss (loss function) is obtained based on the reward and the feature obtained from the input data by the dense embedding layer, and learning is performed so that the loss is reduced.

Arrow lines between the input hidden state, a context, an attention layer, the LSTM, and the soft max indicate an attention-based pointer networks. The loss function is calculated by a reward function and the critic network.

The algorithm calculation unit 130 is configured to learn a large amount of simulation learning data using the neural network illustrated in FIG. 2, and perform a test (vehicle routing preparation) on both actual data and simulation data.

Specifically, by using a reinforcement learning model and a masking algorithm based on actor-critic, the vehicle routing under the constraints can be efficiently calculated and output when a service vehicle constantly arrives at a designated time of a customer (within a designated time window) and each service vehicle constantly works within 8 hours a day.

Hereinafter, processing content of the algorithm calculation unit 130 will be described in more detail.

### (Overview of Processing of Algorithm Calculation Unit 130)

First, an overview of a VRP problem to be solved by the algorithm calculation unit 130 will be described. This problem has the following three elements. In the present specification, a “customer” may also be called a “user”.

(1) A service is provided to all customers and a time at which the service is provided (a time at which a service vehicle arrives) has to be within a time window specified by each customer.

(2) Each customer has a time cost of the service varying in accordance with the service. This “time cost” is a time required for providing the service in a customer home. The service in the customer home is, for example, a repair of a communication facility.

(3) When the service is provided to a plurality of customers, a service vehicle cannot exceed a total service time limit.

The foregoing problem is called “a vehicle routing problem with time windows and time costs” (VRPTWTC).

In the present embodiment, a neural network corresponding to the algorithm calculation unit 130 solves VRPTWTC by end-to-end and data drive based on actor-critic-based deep layer reinforcement learning and outputs a solution (vehicle routing) of the foregoing problem.

Features of the algorithm calculation unit 130 in the present embodiment are as follows.

First, unlike the method of the related art, it is not necessary to define elements of a handmade model such as an objective function and an initial search condition, and a solution of the VRPTWTC in a medium-scale data set (a maximum of 100 customers) can be optimized in a very short processing time (less than 10 seconds). Accordingly, not only an operation cost of an actual business application can be reduced but the method can also be easily developed in an actual industry.

Secondly, a time window designated by a customer and a time cost of a service are strictly taken into consideration during optimization. A violation of the time window and a violation of the total labor time limit are not allowed, which is accordingly useful for an improvement of quality of the service and right protection of a staff.

Finally, unlike another solution to the VRP of the related art, the effectiveness of the algorithm is evaluated using an application programming interface (API) of an actual map in the present embodiment. For example, it is evaluated whether a service vehicle arrives within a designated time window.

Accordingly, applicability of a method proposed in the actual industry is improved.

### (Details of Processing of Algorithm Calculation Unit 130)

Hereinafter, the processing content of the algorithm calculation unit 130 will be described.

### <A: Problem Setting>

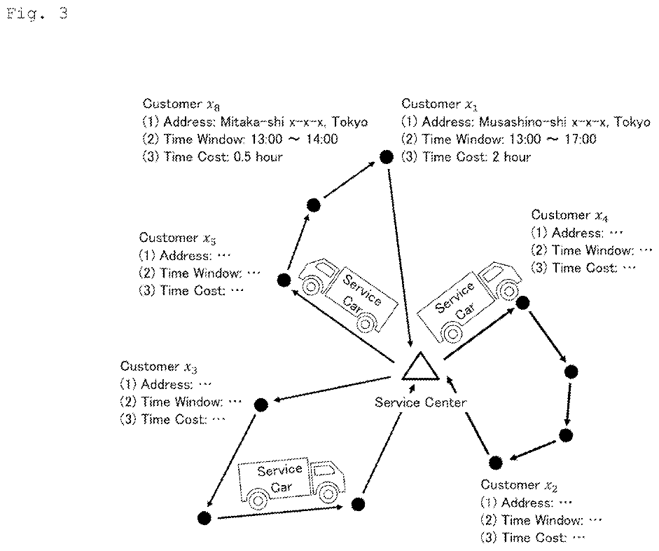

A problem setting in the present embodiment will be described with reference to FIG. 3. A set χ={x₁, x₂, . . . . x_{N}} of customers is located in a certain range on the map, each xₙ in the set is a customer required to be provided with the service. There is a service center performing a load for providing a service. It is assumed that the position of the customer and the position of the service center are known. Traveling times between a customer and the service center and between two arbitrary customers may be known (for example, calculated from a predetermined speed and distance) or may be calculated in consideration of an actual road situation (congestion or the like) from a map API.

First, a set of service vehicles is arranged in the service center. Each service vehicle can leave the service center and provide a service to the set χ of the customers. Each customer receives the service only once by any service vehicle. The service vehicle visits all the planned customers and then returns to the service center.

Since each customer in χ has four features, each customer xₙ is used as a vector and xₙ=[xₙ^{f1}, xₙ^{f2}, xₙ^{f3}, xₙ^{f4}]. xₙ^{f1} is an address of an n-th customer. xₙ^{f2} is a demand of the n-th customer which is the same as the demand feature of a classical VRP problem. xₙ^{f3} is a time window designated by the n-th customer and means that the service vehicle needs to visit the customer during the time window. xₙ^{f4} is a time cost of the service of the n-th customer that indicates how long the service of the n-th customer takes. In order to simplify modeling, the service center is regarded as the 0th customer in the problem formulation.

In this case, it is assumed that a violation of the time window (that the customer cannot be served within the time window) and a violation of the time cost (that the service vehicle works over 8 hours per day) cannot be permitted.

For each service vehicle, a feature of a fixed initial load indicating a maximum loading capacity of a service vehicle providing a service is defined. Specifically, before the service vehicle leaves the service center and provides the service to the customer, a load is initialized with a value of 1 (adjustable according to the task).

A maximum service time is set to 8 hours for each service vehicle. This means that each service vehicle has a service time of a maximum of 8 hours. That is, a longest time for the service vehicle to leave the service center and provide the service is set not to exceed 8 hours (this can be adjusted according to an actual business demand).

The following two conditions (1) and (2) are defined as conditions when the service vehicle provides the service. The service vehicle has to return to the service center in the following cases (1) or (2).

Condition (1): a case in which the load of the service vehicle is close to 0 and a capacity for providing the service to the remaining customers (remaining load) is insufficient.

Condition (2): a case in which the service time of the service vehicle is close to the maximum of 8 hours.

Under the foregoing customer information and a constraint for optimization, a solution ζ for the VRPTWTC is found. The solution ζ is a column (sequence) of customers in χ that can be interpreted as the route of the service or an order of the service. For example, when a column of ζ={0, 3, 2, 0, 4, 1, 0} is obtained as a solution, this column corresponds to two routes. One is a route for traveling 0→3→2→0, and the other is a route for traveling 0→4→1→0, which implies that two service vehicles are used. This can also be interpreted as a case where a certain service vehicle returns to the service center once.

### <B: Pointer Network in Actor Network 131>

The solution ζ of the VRPTWTC is a Markov decision process (MDP) of a column (sequence). This process is a process of selecting a subsequent action in the column (that is, which customer node is to be served subsequently).

In the present embodiment, a pointer network (PointerNet) is used to formulate an MDP process. The pointer network (PointerNet) itself is an existing technique. First, an encoder that has a dense layer embeds features of all input customers and depots (service centers) to extract hidden states. Subsequently, the decoder restores an action of the MDP by using long short-term memory (LSTM) cells connected one by one and transfers the restored action to the attention layer. In each LSTM cell (action), a pointer indicating a probability of the inputted customer node receiving the service is output.

A key difference between the technique disclosed in Non Patent Literature 1 and the technique according to the present embodiment is that a new masking algorithm is designed in the present embodiment, and the masking algorithm is incorporated in the actor network 131 and a solution is obtained under the constraints of the time window, the time cost, and the total time limit.

The dense embedding layer (encoder) of the actor network and the pointer network will be described more specifically.

As described above, each xₙ in χ={x₁, x₂, . . . , x_{N}} indicates a customer (a customer node) and each xₙ is embedded as a dense expression x_{n-dense} by an encoder as shown in Expression (1).

$$[ Math . 1 ]$$

$${x}_{n - dense} = {ω}_{embed} \cdot {x}_{n} + {b}_{embed} \qquad ( 1 )$$

Here, θ_{embedded}={ω_{embed}, b_{embed}} is a learnable parameter represented as a dense layer in an embedding layer in the present embodiment.

The decoder includes a sequence of the LSTM cells. In the decoder, an action in the MDP is modeled using the sequence of the LSTM cells. In each step m∈(1, 2, . . . , M) of the decoder unit, the hidden state of the LSTM cell that has a weight θ_{LSTM} is represented by dₘ. M is s total number of decoder steps.

In the present embodiment, a service order is modeled by calculating the pointer Dₘ similarly to PointerNet. That is, in each step m of the decoder unit, a Softmax result is calculated to determine which member in χ={x₁, x₂, . . . , x_{N}}, is pointed.

Here, p(Dₘ|D₁, D₂ . . . Dₘ₋₁, χ; θ) is modeled by the following Expression (2) and (3) using the LSTM cell that has a parameter θₚₒᵢₙₜₑᵣ as a pointer in each step of the decoder unit.

$$[ Math . 2 ]$$

$${u}_{n}^{m} = {v}^{T} tanh ( {W}_{1} {x}_{n - dense} + {W}_{2} {d}_{m} ) \qquad ( 2 )$$

$$[ Math . 3 ]$$

$$p ( {D}_{m} \vert {D}_{1} , {D}_{2} … . {D}_{m - 1} , χ ; θ ) = softmax ( {u}^{m} ) \qquad ( 3 )$$

Here, Softmax normalizes a vector u^{m} (with a length N) to an output distribution (probability distribution) for all the inputs χ. That is, a probability of each customer (a probability of a customer being selected as a service target) in an m-th step is output by Expression (3). θₚₒᵢₙₜₑᵣ={v, W₁, W₂} is a parameter capable of learning a pointer.

A final output of the actor network 131 is a service route ζ that corresponds to an output of all the m columns (sequences) of LSTM cells. Here, a plurality of LSTMs can be interpreted as MDP. p(Dₘ|D₁, D₂, . . . . Dₘ₋₁, χ; 0) is abbreviated to p(Dₘ).

### <C: Masking>

As described above, in the present embodiment, a new masking algorithm is proposed. The new masking algorithm is coupled to the actor network 131 to optimize the VRPTWTC. In the masking algorithm, there are three types of sub-masking which are load-demand masking, time window masking, and time cost masking.

The load-demand masking is used to solve VRP constraints of the related art. The time window masking and time cost masking are used to optimize new constraints formulated in the VRPTWTC.

The masking algorithm is combined with the actor network 131 to output a probability of an action in reinforcement learning. First, each of these three types of sub-masking will be described. Next, a method of coupling the types of sub-masking in an actor network will be described. Both (2) and (3) may be performed, or any one thereof may be performed.

### (1) Load-Demand Sub-Masking:

Both a service capacity of the service vehicle and a demand of the customer are finite and limited. Therefore, the service vehicle has to return to the service center for supply when a load remaining on the service vehicle disappears.

In this case, the load-demand sub-masking is used to model the process. At each decoder step m∈(1, 2, . . . . M), the remaining demand δ_{n,m} at each customer∈(1, 2, . . . . N) and the remaining vehicle load Δₘ are simultaneously tracked. For m=1, δ_{n,m}=δn and Δₘ=1 are set as initialization and are updated subsequently as follows. Here, Πₘ is an index of a customer selected as a service target in the decoder step m.

$$[ Math . 4 ]$$

$${δ}_{n , m + 1} = \{ \begin{matrix}max ( 0 , {δ}_{n , m} - {Δ}_{m} ) & {π}_{m} = n \\ {δ}_{n , m} & {π}_{m} \neq n\end{matrix} \qquad ( 4 )$$

$$[ Math . 5 ]$$

$${Δ}_{m + 1} = \{ \begin{matrix}max ( {Δ}_{m} - {δ}_{{π}_{m} , m} ) & {π}_{m} \neq 0 \\ 1 & {π}_{m} = 0\end{matrix} \qquad ( 5 )$$

Expression (4) indicates that, when an n-th customer is selected in a decoder step m, a demand of the customer n is larger in the subsequent decoder step m+1 between 0 (representing that the service is received) and a value obtained by subtracting a load from the demand (when the service vehicle is insufficient to provide the entire service). Further, the expression indicates that the demand of another customer other than n is not change.

In Expression (5), when the service vehicle returns to the service center in m+1, a load of the vehicle becomes 1 (a value to be supplemented). Otherwise, the load of the vehicle indicates that a load of the vehicle is a value obtained by subtracting the demand of the customer to be served from the load in m (when the vehicle provides the customer with service). In the formulation of this problem, Πₘ=0 indicates that the service vehicle returns to the service center because the service center is the 0th customer.

### (2) Time Window Sub-Masking:

In the problem setting according to the present embodiment, the service vehicle has to arrive at each customer at a designated time (within a designated time window). Therefore, in each step of the decoder, it is assumed that a time window sub-masking is added and a probability of a customer at which the service vehicle not reach the designated time is set to 0. In this way, setting the probability of the customer to 0 may be called masking or filtering.

As described above, Expression (3) indicates that the pointer (Softmax) normalizes a vector u^{m} to the output probability distribution p(Dₘ) for all the input customers χ. Here, p(Dₘ) is an n-dimensional vector and indicates a probability distribution over the entire χ in the step m of the decoder.

In each step m of the decoder, χ′∈χ indicates a set of customers who need to be served. The reason why such a set is used is that some customers receive the service before the step m or the service vehicle does not have a sufficient load.

For a customer set χ′ of the number N′ of customers, the following processing is repeated for each customer n′ of χ′ to calculate sub-masking τ_{n′,m} of the time window:

$$[ Math . 6 ]$$

$${τ}_{n ′ , m} = 0 , {τ}_{n ′ , m} ∈ p ( {D}_{m} ) \\ if {t}_{total} + {t}_{move} is not in range of {x}_{n}^{f 3} , for all {n}^{′} in {χ}^{′} \qquad ( 6 )$$

Expression (6) is processing for setting τn,m=0 when tₜₒₜₐₗ+tₘₒᵥₑ is not within a range of the time window xₙ^{f3}.

In Expression (6), tₜₒₜₐₗ is a total time to the customer who has received the service immediately before in the current route and tₘₒᵥₑ is a movement time from the customer who has received the service immediately before to the n′. Expression (6) means that, when a value obtained by adding the total time cost tₜₒₜₐₗ in a certain route and the time tₘₒᵥₑ spent for moving from the previous customer to the current customer n′ exceeds the designated time window of the current customer n′, a probability of visit to the customer is set to 0

### (3) Time Cost Sub-Masking:

The time cost sub-masking is used to forcibly return the service vehicle to the service center when the total time cost tₜₒₜₐₗ exceeds 8 hours, and is expressed by the following Expression (7).

$$[ Math . 7 ]$$

$$p ( {D}_{m} ) = 1 , if n = 0 , when {t}_{total} > 8 hours \\ p ( {D}_{m} ) = 0 , if n = ! 0 , when {t}_{total} > 8 hours \qquad ( 7 )$$

Expression (7) means that p(Dₘ) of n=0 is set to 1 and p(Dₘ) of n other than 0 is set to 0 when the total time cost tₜₒₜₐₗ exceeds 8 hours. Here, n=0 means that a customer is the service center. As described above, the service center is the 0th customer in the formulation of this problem. tₜₒₜₐₗ may be referred to as total operation time.

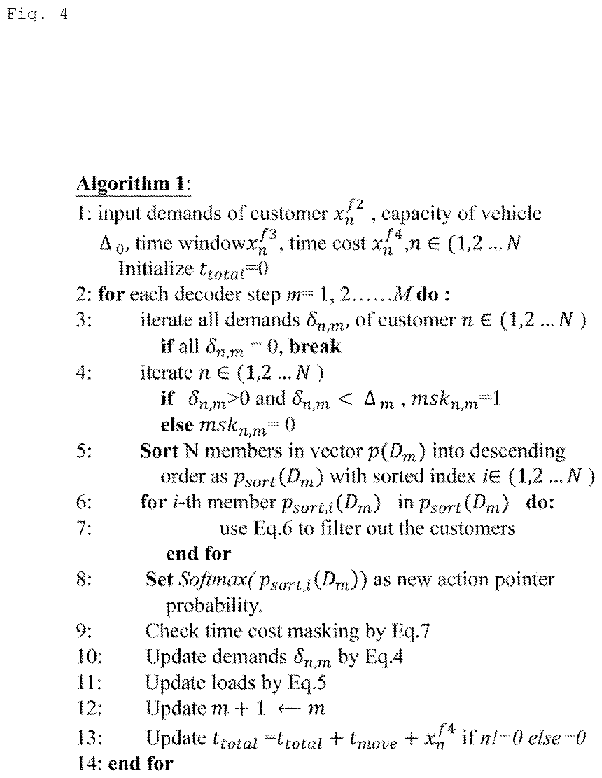

FIG. 4 illustrates an algorithm (Algorithm 1) of the masking processing. This is processing executed by the masking (masking unit) of FIG. 2. In the first line, for each customer n∈(1, 2, . . . . N), a demand xₙ^{f2} of the customer, a capacity Δ0, a time window xₙ^{f3}, a time cost xₙ^{f4} of a vehicle are input, and tₜₒₜₐₗ is initialized to 0.

The 2nd line means that step 3-13 is repeated in each decoder step m=1, 2, . . . . M. In the 3rd line, if the remaining demand δ_{n,m}=0 for all the customers n∈(1, 2, . . . . N) in the step m, the loop processing ends.

In the 4th line, when δ_{n,m}>0 and δ_{n,m}<Δₘ are satisfied for each customer n∈(1, 2, . . . . N), msk_{n,m}=1. Otherwise, msk_{n,m}=0. msk_{n,m}=1 indicates that the service is available. msk_{n,m}=0 indicates that the service ends or the vehicle capacity is insufficient and indicates that the customer is not a service target (the probability is set to 0).

In the 5th line, N members of a vector p(Dₘ) are sorted in descending order to obtain pₛₒᵣₜ(Dₘ) with a sorted index i (1, 2, . . . . N).

In the 6th and 7th lines, the customer is filtered (masked) based on Expression (6) (time window sub-masking) for each i-th member p_{sort,i}(Dₘ) in pₛₒᵣₜ(Dₘ).

In the 8th line, Softmax (p_{sort,i}(Dₘ)) is set as a probability of a new action pointer. In the 9th line, the time cost masking is checked By Expression (7).

In the 10th line, the remaining demand δ_{n,m} is updated by Expression (4). In the 11th line, the remaining load is updated by Expression (5). In the 12th line, m is updated to m+1. In the 13th line, when n is not 0, it is assumed that tₜₒₜₐₗ=tₜₒₜₐₗ+tₘₒᵥₑ+xₙ^{f4}. This means that a value obtained by adding a movement time from a customer to a subsequent customer and a time cost of the subsequent customer to the total operation time from the service center to completion of the service for the customer is defined as a total operation time of the subsequent customer. In the 14th line, the processing ends.

As illustrated in FIG. 4, three types of sub-masking are introduced to the masking algorithm shown in Algorithm 1. After data input and initialization, in each step m of the LSTM-based decoder, first, for each demand of the customer, the decoder loop ends when all the demands are 0, that is, when all the customers receive the service.

If not, all the customers having demand values which are not zero are masked with 1. The demand value has to be smaller than a dynamic load of the vehicle.

Next, the members of the vector p(Dₘ) which is a probability of a pointer generated in the action network 131 are sorted in descending order to obtain psort(Dₘ). Then, by using Expression (6), customers who cannot use the service are filtered into p_{sort,i}(Dₘ) in consideration of the time window and the total time cost of the current service route, p_{sort,i}(Dₘ) is normalized using the Softmax.

Further, it is confirmed whether the total time cost tₜₒₜₐₗ exceeds 8 hours using Expression (7). When the total time cost tₜₒₜₐₗ exceeds 8 hours, the service vehicle is returned to the service center (the 0th customer). Finally, the dynamic demand δ_{n,m}, the dynamic load Δₘ, and the total time cost tₜₒₜₐₗ are updated. The processing proceeds to the subsequent decoder step m+1.

### <D: Actor-Critic>

In the present embodiment, deep reinforcement learning based on the actor-critic is used to learn both the policy and the value function at the same time. The deep reinforcement learning based on the actor-critic is a known technique.

The actor network 131 has a learnable weight θ_{actor}={θ_{embedded}, θ_{LSTM}, θₚₒᵢₙₜₑᵣ} as described in A.

In the present embodiment, a stochastic policy n is parameterized by using the pointer parameter θₚₒᵢₙₜₑᵣ={ν, W₁, W₂} and the LSTM parameter θ_{LSTM} in the actor network 131. The stochastic policy n generates a probability distribution for a subsequent action (which customer visits) in any given decoder step.

On the other hand, the critic network 132 having a learnable parameter θ_{critic} estimates a gradient for any problem instance from a given state in reinforcement learning.

The critic network 132 includes three dense layers, inputs static and dynamic states, and predicts a reward. In the present embodiment, the output probability of the actor network 131 is used as a weight, and the weighted sum of the embedded inputs (outputs from the dense layers) is calculated to output a single value. This can be interpreted as an output of the value function predicted by the critic network 131.

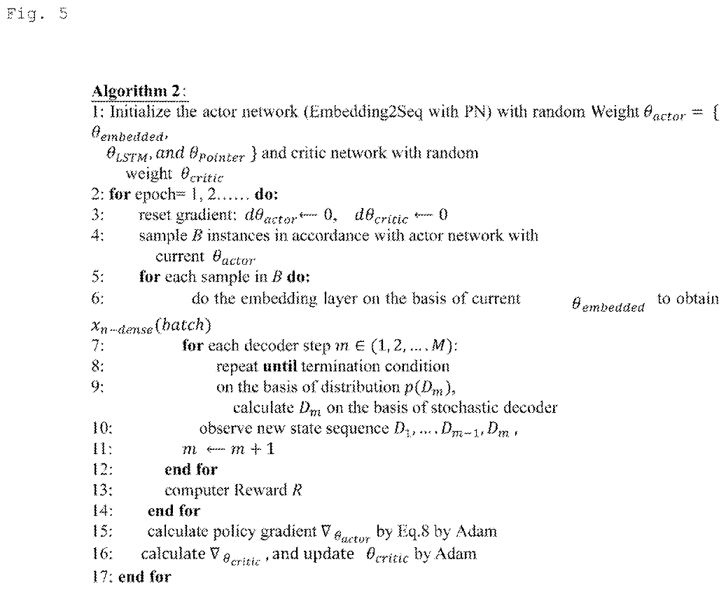

FIG. 5 illustrates an actor-critic algorithm (Algorithm 2).

In the first line, an actor network (Embedding2Seq with PN) is initialized by a random weight θ_{actor}={θ_{embedded}, θ_{LTSM}, θₚₒᵢₙₜₑᵣ}, and a critic network is initialized by a random weight θ_{critic}. The 2nd and 17th lines mean that the 3rd to 16th lines are repeated in each epoch.

In the 3rd line, dθ_{actor} and dθ_{critic} which are gradients of parameters, are reset to 0. In a 4th line, B instances are sampled according to the actor network having the current θ_{actor}. The 5th and 14th lines mean that the 6th to 13th lines are repeated for each sample in B.

In the 6th line, the embedding layer is processed based on the current. θ_{embedded} to obtain X_{n-dense} (batch). The 7th and 12th lines mean that the 8th to 11th lines are repeated in each decoder step m∈(1, 2, . . . . M). The 8th line means that the 9th to 11th lines are repeated as long as an end condition is satisfied.

In the 9th line, Dₘ is calculated based on the distribution p(Dₘ) and a stochastic decoder. Dₘ indicates a customer to be a served (visit destination) in the m-th step.

In the 10th line, columns D₁, . . . , Dₘ₋₁, Dₘ in a new state are observed. In the 11th line, m is updated to m+1.

In the 13th line, a reward R is calculated. In the 15th line, a policy gradient ∇θ_{actor} by Expression (8) is calculated to update θ_{actor}. In the 16th line, the gradient ∇θ_{critic} is calculated and θ_{critic} is updated.

The actor-critic Algorithm 2 in the present embodiment illustrated in FIG. 5 indicates learning processing. After the learning processing, a test (actual vehicle routing output) may be performed or a test may be performed while learning is being progressed.

As described above, two neural networks (the actor network and the critic network) having the weight vectors θ_{actor} and θ_{critic} are used. θ_{actor} includes θ_{embedded}, θ_{LTSM}, and θₚₒᵢₙₜₑᵣ.

In the repetition of each learning having the current weight θ_{actor} of the actor network, B samples are acquired, and a column (sequence) that can be implemented is generated based on the current policy by using Monte Carlo simulation. This means that, in each step of the decoder, the pointer Dₘ is stochastically calculated based on the distribution p(Dₘ) which is an output of the actor network.

When the sampling ends, a reward and a gradient of policy are calculated, and the actor network is updated in the 15th line. In this step, V (Dₘ; θ_{critic}) is a value function approximated from the critic network.

In the 16th line, the critic network is updated in a direction in which a difference between an observed reward and an expected reward is reduced. Finally, θ_{actor} and θ_{critic} are updated at the same learning rate using the gradient dθ_{actor} and the gradient dθ_{critic} in accordance with an end-to-end method. Hereinafter, the policy gradient and the reward will be described.

### (1) Policy Gradient

In the 15th line of Algorithm 2, the policy gradient of the actor network is approximated by Monte Carlo sampling as follows:

$$[ Math . 8 ]$$

$${∇}_{{θ}_{actor}} = \frac{1}{B} {\sum }_{b = 1}^{B} ( R - V ( χ ; {θ}_{critic} ) ) \cdot log p ( {D}_{m} ) \qquad ( 8 )$$

Here, R is a reward for a route instance, and is a reward for a column of Dₘ indicating a serving route. V (χ; θ_{critic}) is a value function of predicting rewards for all raw inputs. “R-V (χ; θ_{critic}) is used as an advantage function instead of a cumulative reward of the VRP method based on reinforcement learning of the related art. In the actor-critic, a scheme itself of using an advantage function is a known technique.

### 2) Reward

In the present embodiment, a reward function based on a length of a tour (total route) is used similarly to the known technique. A penalty term for adding a penalty value when a time window is violated may be included. Using the length of the tour is exemplary and a reward function other than a length may be used.

### (Exemplary Hardware Configuration)

The vehicle routing device 100 can be implemented, for example, by causing a computer to execute a program. The computer may be a physical computer or a virtual machine on a cloud.

That is, the vehicle routing device 100 can be implemented by executing a program corresponding to processing executed by the vehicle routing device using hardware resources such as a CPU and a memory that are built into the computer. The program can be recorded in a computer-readable recording medium (such as a portable memory) to be stored or distributed. The program can also be provided through a network such as the Internet or email.

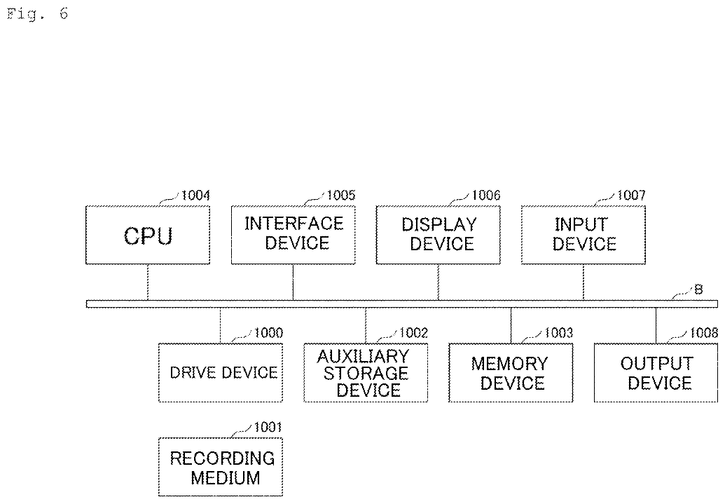

FIG. 6 is a diagram illustrating an exemplary hardware configuration of the computer. The computer illustrated in FIG. 6 includes a drive device 1000, an auxiliary storage device 1002, a memory device 1003, a CPU 1004, an interface device 1005, a display device 1006, an input device 1007, and an output device 1008 connected to each other via a bus BS.

The program implementing the processing in the computer is provided by, for example, a recording medium 1001 such as a CD-ROM or a memory card. When the recording medium 1001 storing the program is set in the drive device 1000, the program is installed from the recording medium 1001 to the auxiliary storage device 1002 through the drive device 1000. However, the program need not necessarily be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when an instruction to start the program is received. The CPU 1004 implements a function related to the light touch maintaining device 100 according to a program stored in the memory device 1003. The interface device 1005 is used as an interface for connection to a network. The display device 1006 displays a graphical user interface (GUI) or the like by the program. The input device 1007 is configured with a keyboard and a mouse, buttons, a touch panel, or the like and is used to input various operation instructions. The output device 1008 outputs a calculation result.

### (Advantageous Effects of Embodiment)

As described above, by the technique according to the present embodiment, the advantageous effects described in the following (1), (2), (3) are obtained.

(1) It is possible to reduce a calculation time of a vehicle allocation considerably as compared with a case of the related art in which a vehicle allocation of service vehicles is manually generated. That is, in a NP-hard VRP problem, it is difficult to manually calculate a VRP problem since the larger the number of customers is, the larger an amount of calculation is. Even when there are 50 to 100 customers which cannot be handled by a OR-based method of the related art, calculation within one second can be performed by the technique according to the present embodiment.

(2) In the VRP problem, it is possible to optimize a route in consideration of restrictions between an arrival of a customer at a designated time and work of each service vehicle within 8 hours per day.

(3) By utilizing the map API, an actual movement route and movement time can be calculated and an image of the route can be output. Therefore, a more accurate experiment and an easy-to-understand vehicle allocation can be output.

### (Conclusion of Embodiment)

The present specification discloses, at least, a vehicle routing device, a vehicle routing method, and a program according to each of the following clauses.

### (Clause 1)

A vehicle routing device including an algorithm calculation unit configured to solve a vehicle routing problem that determines a route for providing a service to a plurality of customers by a vehicle starting from a service center using a neural network performing reinforcement learning by an actor-critic scheme,
wherein the algorithm calculation unit solves the vehicle routing problem with a time window indicating a range of a time to arrive at a customer and a time cost indicating a time length taken to provide the service to the customer as constraints.

### (Clause 2)

The vehicle routing device according to Clause 1, wherein the algorithm calculation unit masks customers who do not satisfy the constraint of the time window for a probability distribution of customers obtained by using a decoder in the neural network.

### (Clause 3)

The vehicle routing device according to Clause 1 or 2, wherein the algorithm calculation unit performs masking for a probability distribution of the customers obtained by using the decoder in the neural network so that the vehicle returns to the service center when a value based on a total operation time of the vehicle exceeds a threshold.

### (Clause 4)

The vehicle routing device according to Clause 3, wherein the algorithm calculation unit sets a value obtained by adding, to a total operation time from the service center to completion of the service for a certain customer, a movement time from the customer to a subsequent customer and a time cost in the subsequent customer as the total operation time in the subsequent customer.

### (Clause 5)

The vehicle routing device according to any one of Clauses 1 to 4, further comprising a map API unit configured to draw, on a map, a route of visit to each customer, which is a vehicle routing calculated by the algorithm calculation unit.

### (Clause 6)

A vehicle routing method executed by a vehicle routing device, the method including:
an algorithm calculation step of solving a vehicle routing problem that determines a route for providing a service to a plurality of customers by a vehicle starting from a service center using a neural network performing reinforcement learning by an actor-critic scheme,
wherein, in the algorithm calculation step, the vehicle routing problem with a time window indicating a range of a time to arrive at a customer and a time cost indicating a time length taken to provide the service to the customer as constraints is solved.

### (Clause 7)

A program causing a computer to function as each unit of the vehicle routing device according to any one of Clauses 1 to 5.

Although the embodiment has been described above, the present invention is not limited to the specific embodiment, and various modifications and changes can be made within the scope of the gist of the present invention described in the claims.

### REFERENCE SIGNS LIST

100 Vehicle routing device
110 User Information collection unit
120 Service vehicle Information collection unit
130 Algorithm calculation unit
140 Map API unit
150 Vehicle allocation unit
1000 Drive device
1001 Recording medium
1002 Auxiliary storage device
1003 Memory device
1004 CPU
1005 Interface device
1006 Display device
1007 Input device
1008 Output device

1. A vehicle routing device comprising:
a processor; and
a memory storing program instructions that cause the processor to solve a vehicle routing problem that determines a route for providing a service to a plurality of customers by a vehicle starting from a service center using a neural network performing reinforcement learning by an actor-critic scheme,
wherein the program instructions cause the processor to solve the vehicle routing problem with a time window indicating a range of a time to arrive at a customer and a time cost indicating a time length taken to provide the service to the customer as constraints.

2. The vehicle routing device according to claim 1, wherein the program instructions cause the processor to mask customers who do not satisfy the constraint of the time window for a probability distribution of customers obtained by using a decoder in the neural network.

3. The vehicle routing device according to claim 1, wherein the program instructions cause the processor to perform masking for a probability distribution of the customers obtained by using the decoder in the neural network so that the vehicle returns to the service center when a value based on a total operation time of the vehicle exceeds a threshold.

4. The vehicle routing device according to claim 3, wherein the program instructions cause the processor to set a value obtained by adding, to a total operation time from the service center to completion of the service for a certain customer, a movement time from the customer to a subsequent customer and a time cost in the subsequent customer as the total operation time in the subsequent customer.

5. The vehicle routing device according to claim 1, wherein the program instructions cause the processor to draw, on a map, a route of visit to each customer, which is the calculated vehicle routing.

6. A vehicle routing method executed by a vehicle routing device, the method comprising:
solving a vehicle routing problem that determines a route for providing a service to a plurality of customers by a vehicle starting from a service center using a neural network performing reinforcement learning by an actor-critic scheme, wherein, in the algorithm calculation step, the vehicle routing problem with a time window indicating a range of a time to arrive at a customer and a time cost indicating a time length taken to provide the service to the customer as constraints is solved.

7. A non-transitory computer-readable recording medium having stored therein a program causing a computer to perform the vehicle routing method according to claim 6.
